(19) United States
(12) Patent Application Publication
(10) Pub. No.: US 2013/0209655 A1
(43) Pub. Date: Aug. 15, 2013

(54) REDUCED TRANS AND SATURATED FATTY ACID SPREAD COMPOSITIONS

(71) Applicants: Dilip K. NAKHASI, Bourbonnais, IL (US); Danielle N. CORBIN, Richton Park, IL (US); Leslie KLEINER, Bourbonnais, IL (US); Vishal P. JAIN, Tinley Park, IL (US)

(72) Inventors: Dilip K. NAKHASI, Bourbonnais, IL (US); Danielle N. CORBIN, Richton Park, IL (US); Leslie KLEINER, Bourbonnais, IL (US); Vishal P. JAIN, Tinley Park, IL (US)

(73) Assignee: Bunge Oils, Inc., St. Louis, MO (US)

(21) Appl. No.: 13/840,413

(22) Filed: Mar. 15, 2013

Related U.S. Application Data
(63) Continuation-in-part of application No. 13/366,201, filed on Feb. 3, 2012.

(51) Int. Cl. A23D 7/00

(52) U.S. Cl. CPC A23D 7/001
USPC 426/604; 426/603; 426/659; 426/417

(57) ABSTRACT

Described herein are spread compositions having reduced levels of saturated and trans fats. The compositions comprise water, a base oil, a seeding agent and a cellulose fiber. Also provided are methods of preparing such compositions and use thereof.

### RELATED APPLICATIONS

This application is a continuation-in-part of and claims priority to U.S. patent application Ser. No. 13/366,201, filed on Feb. 3, 2012, which is hereby incorporated by reference herein in its entirety.

### FIELD

Provided herein are spread compositions having reduced levels of saturated and trans fatty acids as compared to the traditional spread compositions. The compositions provided herein comprise a seeding agent, a cellulose fiber, water, and a base oil. Also provided are methods of preparing such compositions and uses thereof.

### BACKGROUND

Recent trends in the field of spread products have been directed to the development of reduced trans fat and reduced saturated fat products which also possess the desired functional properties, including the texture and spreadability. While reduced trans fat and reduced saturated fat spreads are desirable, it has been observed that spreads having less than about 40% fat suffer from severe emulsion instability after prolonged storage at refrigerator temperature. Pools of oil and moisture are observed in such products and it is believed that the fat of the products recrystallize upon storage causing the emulsion instability problem.

To address this problem, in part, substantial work has been carried out with bulking agents such as powdered and microcrystalline cellulose in the spread products. However, reducing the trans fats and saturated fats adversely affect the organoleptic properties of the products and create undesirable mouthcoating or drying sensation.

There is a continuing need for spread compositions having reduced levels of saturated fats and trans fats, and acceptable mouthfeel and physical properties for handling and food preparation.

### SUMMARY

In certain embodiments, provided herein are spread compositions with reduced levels of both trans fatty acids and saturated fatty acids, wherein the compositions comprise a seeding agent, a cellulose fiber, a base oil and an aqueous phase.

In certain embodiments, the spread compositions provided herein comprise about 40-65% aqueous phase, 1-25% seeding agent, 1-15% cellulose fiber, and 10-40% base oil based on the total weight of the composition. In certain embodiments, the spread compositions provided herein comprise about 40-60% water, 3-19% seeding agent, 3-10% cellulose fiber, and 15-19% base oil based on the total weight of the composition.

The seeding agent used herein is a blend of a diacylglyceride (DAG), a monoacylglyceride (MAG), and a triacylglyceride (TAG). In certain embodiments, the seeding agent comprises about 15-55% DAG, 4-15% MAG and 30-80% TAG based on the total weight of the seeding agent.

In certain embodiments, the base oil used herein comprises triglycerides, fatty acids and fatty acid derivatives of natural or synthetic origin, including, but not limited to high oleic canola, soybean, palm, corn, sunflower, coconut oil, rapeseed, peanut, safflower, high oleic safflower oil, olive, cottonseed, or a mixture thereof.

In another embodiment, provided herein is a method for preparing the spread compositions described herein. In certain embodiments, the method comprises mixing the base oil and seeding agent to obtain an oil mixture, adding cellulose to the oil mixture to obtain an oil-cellulose mixture, adding water to the oil-cellulose mixture followed by shearing and cooling to provide the spread composition. The order of adding the ingredients can be changed as required by a particular process. In certain embodiments, cooling is carried out with agitation.

In certain embodiments, the spread compositions so produced have lower levels of saturated fats than the margarine compositions known in the art. In certain embodiment, the compositions provided herein are used in bakery products, e.g., cookies, cakes, pie crusts, breads, icings and other products in place of conventional margarine spreads.

It is to be understood that both the foregoing general description and the following detailed description are exemplary and explanatory only and are not restrictive.

### BRIEF DESCRIPTION OF DRAWINGS

FIG. 1 provides a microscopic image of a sample of Example 42B using a polarized light source.

FIG. 2 provides a microscopic image of a sample of Example 42B using a cross polarized light source.

FIG. 3A provides (%) DAG in reaction products, as a function of time.

FIG. 3B demonstrates changes in TAG profile of products, as a function of time.

FIG. 4 provides (%) DAG in reaction products, as a function of time.

FIG. 5 provides (%) DAG in reaction products, as a function of time.

### DETAILED DESCRIPTION

Provided herein are spread compositions comprising a seeding agent, a cellulose fiber, water, and a base oil. Further provided are methods of making the compositions and uses of the compositions. The methods and compositions are described in detail in the sections below.

### DEFINITIONS

Unless defined otherwise, all technical and scientific terms used herein have the same meaning as is commonly understood by one of ordinary skill in the art. All patents, applications, published applications and other publications are incorporated by reference in their entirety. In the event that there are a plurality of definitions for a term herein, those in this section prevail unless stated otherwise.

The term “seeding agent” or “specialty ester” as used herein refers to a blend of diglycerides (DAGs), monoglycerides (MAGs) and triglycerides (TAGs) in specific amounts. In certain embodiments, the seeding agent comprises about 15-55% DAGs and 4-15% MAGs and 30-80% TAGs based on the total weight of the seeding agent. The seeding agent can be prepared using a method described herein or any method known to one of skill in the art.

The term “base oil” as used herein refers to an oil which is substantially liquid at room temperature and has an iodine value of greater than 70, or greater than 90. The base oil can be an unhydrogenated oil or a partially hydrogenated oil, a modified oil or a mixture thereof. Natural and synthetic fats and oils are included in this term.

The term “oil blend” refers to a blend comprising two or more oils suitable for use in the compositions herein. In one embodiment, the oil blend comprises palm oil and soybean oil. In certain embodiments, the oil blend comprises palm oil, palm stearin, soybean oil, and emulsifiers.

The term “saturates”, “saturated fat”, and “saturated fatty acids” as used herein refer to C₄ to C₂₆ fatty acids or esters containing no unsaturation.

The term “trans”, and “trans fatty acids” as used herein refer to fatty acids and/or esters containing double bonds in the trans configuration, generally resulting from the hydrogenation or partial hydrogenation of a fat.

The term “iodine value” or “IV” as used herein refers to the number of grams of iodine equivalent to halogen adsorbed by a 100 gram sample of fat. The IV is a measure of the unsaturated linkages in a fat.

As used herein, “cellulose fiber” refers to a fibrous cellulose material obtained from plant sources. The fibrous nature of the material and the existence of capillaries that can take up oil is an important feature for the cellulose fiber used herein. Exemplary cellulose fibers are obtained from wood pulp, pea and bamboo. In certain embodiments, cellulose fibers are obtained from wood pulp, pea, bamboo, wheat and cottonseed.

As used herein, the degree of crystallinity is defined by the ratio between the absorbance bands observed at 1372 cm⁻¹ and 2900 cm⁻¹ (degree of crystallinity (%)=A1372/A2900). Most cellulosic materials are comprised of an amorphous and a crystalline domain, with the amorphous domain being the site for most reactions (e.g. hydration). Therefore, the degree of crystallinity expresses the ratio between crystalline (1372 cm⁻¹) and amorphous areas (2900 cm⁻¹ band), and in consequence the availability of reacting sites within a fiber.

As used herein, “oil phase” refers to a mixture or solution of one or more base oils, a seeding agent, a cellulose fiber, and one or more additives selected from emulsifiers, salt, preservatives, flavoring agents, coloring agents and other additives known to one of skill in the art.

As used herein, “aqueous phase” refers to water or an aqueous solution or mixture comprising water, and one or more additives selected from salt, preservatives, flavoring agents, coloring agents and other additives known to one of skill in the art.

It must be noted that, as used in the specification and the appended claims, the singular forms “a,” “an” and “the” include plural referents unless the context clearly dictates otherwise. Thus, for example, reference to “a vegetable oil” includes mixtures of two or more such vegetable oils, and the like. In one embodiment, reference to “a vegetable oil” includes interesterified and/or genetically modified oils.

All percent values are given as weight percent unless expressly stated otherwise.

Compositions

In certain embodiments, provided herein are spread compositions comprising a seeding agent, a cellulose fiber, water, and a base oil. Without being bound to any particular theory, it is believed that in certain embodiments, the cellulose fiber and seeding agent act synergistically to impart the desired crystalline structure to the composition. In certain embodiments, the compositions provided herein have about 15-60% less saturated and trans fatty acids as compared to the margarine compositions known in the art. In certain embodiments, the compositions provided herein have about 25-50% less saturated and trans fatty acids as compared to the margarine compositions known in the art.

In certain embodiments, the compositions provided herein have about 15-50% less saturated fatty acids as compared to the margarine compositions known in the art. In certain embodiments, the compositions provided herein have about 20-50% less, about 25-50% less, about 25-45% less or about 30-40% less saturated fatty acids as compared to the margarine compositions known in the art. In certain embodiments, the compositions provided herein have about 50%, 45%, 40%, 35%, 32%, 30%, 25%, 20% or 15% less saturated fatty acids as compared to the margarine compositions known in the art.

In certain embodiments, the compositions provided herein have about 15-50% less trans fatty acids as compared to the margarine compositions known in the art. In certain embodiments, the compositions provided herein have about 20-50% less, about 25-50% less, about 25-45% less or about 25-40% less trans fatty acids as compared to the margarine compositions known in the art. In certain embodiments, the compositions provided herein have about 50%, 45%, 40%, 35%, 32%, 30%, 25%, 20% or 15% less trans fatty acids as compared to the margarine compositions known in the art.

In certain embodiments, the spread compositions provided herein comprise about 40-65% water, 1-25% seeding agent, 1-15% cellulose fiber, and 10-25% base oil based on the total weight of the composition.

In certain embodiments, the spread compositions provided herein comprise about 40-65%, 42-60%, 45-58% or 45-55% water based on the total weight of the composition. In certain embodiments, the spread compositions provided herein comprise about 40, 45, 50, 55, or 60% water based on the total weight of the composition.

The seeding agent used in the compositions herein comprises a blend of a diacylglyceride (DAG), a monoacylglyceride (MAG) and a triacylglyceride (TAG). In certain embodiments, the seeding agent further comprises free fatty acids and fatty acid derivatives.

In certain embodiments, the acyl portion in the diacylglyceride comprises saturated or unsaturated medium to long chain fatty acids. In certain embodiments, the acyl portion in the diacylglyceride comprises fatty acids selected from lauric acid, myristic acid, palmitic acid, stearic acid, behenic acid, oleic acid, linoleic acid and linolenic acid.

In certain embodiments, the acyl portion in the monoacylglyceride comprises saturated or unsaturated medium to long chain fatty acids. In certain embodiments, the acyl portion in the monoacylglyceride comprises fatty acids selected from, lauric acid, myristic acid, palmitic acid, stearic acid, behenic acid, oleic acid, linoleic acid and linolenic acid.

In certain embodiments, the acyl portion in the triacylglyceride comprises saturated or unsaturated medium to long chain fatty acids. In certain embodiments, the acyl portion in the triacylglyceride comprises fatty acids selected from lauric acid, myristic acid, palmitic acid, stearic acid, behenic acid, oleic acid, linoleic acid and linolenic acid.

In certain embodiments, the seeding agent comprises about 15-55% DAG based on the total weight of the seeding agent and a remaining portion comprising MAG and TGA. In certain embodiments, the seeding agent comprises about 15-55% DAG based on the total weight of the seeding agent and a remaining portion comprising TAG. In certain embodiments, the remaining portion comprises TAG, free fatty acids and free fatty acid esters.

In certain embodiments, the seeding agent comprises about 20-50% DAG based on the total weight of the seeding agent, 4-15% MAG based on the total weight of the seeding agent and remaining portion comprising TAG. In certain embodiments, the seeding agent comprises about 20-50% DAG based on the total weight of the seeding agent, 4-15% MAG based on the total weight of the seeding agent and remaining portion comprising TAGs, free acids and fatty acid derivatives. In certain embodiments, the seeding agent comprises about 20-50% DAG, 4-15% MAG and 30-70% TAG based on the total weight of the seeding agent. In certain embodiments, the seeding agent comprises about 30-35% DAG, 8-10% MAG and 50-60% TAG based on the total weight of the seeding agent. In certain embodiments, the seeding agent comprises about 15-55%, 25-50%, 30-50%, 20-40%, 25-35% or 30-35% DAG based on the total weight of the seeding agent. In certain embodiments, the seeding agent comprises about 25-35% DAG based on the total weight of the seeding agent. In certain embodiments, the seeding agent comprises about 30-40% DAG based on the total weight of the seeding agent. In certain embodiments, the seeding agent comprises about 5-10%, 6-10%, 7-10% or 8-10% MAG based on the total weight of the seeding agent. In certain embodiments, the seeding agent comprises about 8-10% MAG based on the total weight of the seeding agent. In certain embodiments, the seeding agent comprises about 35-75%, 35-70%, 40-70%, 45-65% or 45-70% TAG based on the total weight of the seeding agent. In certain embodiments, the seeding agent comprises about 45-70% TAG based on the total weight of the seeding agent. In certain embodiments, the seeding agent further comprises about 1-30% free fatty acids and fatty acid derivatives based on the total weight of the seeding agent. In certain embodiments, the seeding agent comprises about 5-30%, 10-30%, 5-15%, 15-30% or 10-20% free fatty acids and fatty acid derivatives based on the total weight of the seeding agent. In certain embodiments, the seeding agent comprises about 25-40% DAG based on the total weight of the seeding agent, 6-12% MAG based on the total weight of the seeding agent and remaining portion comprising TAG, free fatty acids and free fatty acid esters. In certain embodiments, the seeding agent comprises about 25-40% DAG, 6-12% MAG and 45-65% TAG based on the total weight of the seeding agent. In certain embodiments, the seeding agent comprises about 30-35% DAG based on the total weight of the seeding agent, 8-10% MAG based on the total weight of the seeding agent and remaining portion comprising TAG, free fatty acids and free fatty acid esters. In certain embodiments, the seeding agent comprises about 30-35% DAG, 8-10% MAG and 45-50% TAG based on the total weight of the seeding agent.

In certain embodiments, the spread compositions provided herein comprise about 1-25%, 1-20%, 2-20%, 3-20%, 3-19%, 4-17%, 5-17% or 6-20% seeding agent based on the total weight of the composition. In certain embodiments, the spread compositions provided herein comprise about 5, 8, 9, 10, 15, 17, 19 or 20% seeding agent based on the total weight of the composition.

Any cellulose material having fibrous nature and capillaries that can take up oil can be used in the compositions provided herein. In certain embodiments, the cellulose fibers for use herein are obtained from plant sources, including but not limited to wood pulp, bamboo, pea, citrus fruit and sugar beets. In certain embodiments, the cellulose fibers for use herein are obtained from plant sources, including but not limited to wood pulp, bamboo, pea, citrus fruit, sugar beets, wheat and cottonseed. In certain embodiments, the cellulose fibers are obtained from bamboo. In certain embodiments, the cellulose fibers have an average fiber length of about 15-60 micron, 15-50 micron, 20-50 micron, 20-40 micron, 25-35 micron, or 25-40 micron. In certain embodiments, the cellulose fibers have an average fiber length of about 25, 30 or 35 micron. In certain embodiments, the cellulose fibers have an average fiber thickness of about 0.5-5 micron, 1-5 micron, 1-3 micron, or 1-2 micron. In certain embodiments, the cellulose fibers have an average fiber length of about 1-2 micron.

In certain embodiments, the cellulose fiber used is in the formulation is selected from NutraFiber 200, Just Fiber BF 200, Just Fiber BVF 200 and Solka Floc 40 FCC (from International Fiber Corporation). In certain embodiments, the cellulose fiber used is CREAFIBE QC 40. In certain embodiments, the cellulose fiber used is CREAFIBE SC 40. In certain embodiments, the cellulose fiber used is Solka-Floc 300 FCC. In certain embodiments, cellulose fibers having a range of average lengths, processed from different source materials and of different levels of purity can be used.

In certain embodiments, the compositions provided herein comprise the cellulose fiber in an amount from about 1 to about 15% by weight based on the total weight of the composition. In certain embodiments, the amount of the cellulose fiber in the compositions is about 1%-10%, about 3%-10%, about 3%-7%, about 4%-7% or about 2%-5% by weight based on the total weight of the composition. In certain embodiments, the amount of the cellulose fiber in the compositions is about 3%-5% or about 4%-5% by weight based on the total weight of the composition. In certain embodiments, the amount of the cellulose fiber in the compositions is about 1, 2, 3, 4, 5, 6, 7, 8, 9, 10, 11, 12, 13, 14 or 15% by weight based on the total weight of the composition. In certain embodiments, the amount of the cellulose fiber in the compositions is about 5% by weight based on the total weight of the composition.

In certain embodiments, the base oil used herein comprises one or more saturated or unsaturated triglycerides, fatty acids and fatty acid derivatives of natural or synthetic origin. In certain embodiments, base oil is any oil or mixture of oils that is substantially liquid at room temperature and has an iodine value of greater than 70, greater than 80 or greater than 90. In certain embodiments, the base oil has an iodine value of about 70-100, 80-95, 85-95 or 90-95. In certain embodiments, the base oil has an iodine value of about 70, 80, 85, 88, 89, 90, 91, 92, 93 or 95. Examples of fatty acids include without limitation, oleic acid, linoleic acid, linolenic acid, alpha-linolenic acid, arachidonic acid, eicosapentaenoic acid, erucic acid, docosahexaenoic acid, palmitic acid, stearic acid, behenic acid, or combinations thereof. The sources of fatty acids are generally substrates of natural origin. Suitable substrates of natural origin include without limitation, vegetable oils, rapeseed oil, animal fats, corn oil, canola oil, olive oil, cottonseed oil, safflower oil, high oleic safflower oil, palm oil, soybean oil, sunflower oil, peanut oil, coconut oil, or other oils and triglycerides of natural origin, as well as fatty acids and/or fatty acid derivatives obtained therefrom. In certain embodiments, the base oil used herein comprises high oleic canola oil, soybean oil, palm oil, corn oil, sunflower oil, rapeseed oil, peanut oil, safflower oil, high oleic safflower oil, olive oil, cottonseed oil, or a mixture thereof. In certain embodiments, the base oil used herein further comprises an emulsifier. In certain embodiments, the base oil used herein comprises soybean oil, palm oil, or a mixture thereof. In certain embodiments, the base oil used herein comprises a blend of palm oil, palm stearin, soybean oil, and emulsifiers. In certain embodiments, emulsifier comprises monoacylglycerides, diacylglycerides, polyglycerol esters and lecithin. In certain embodiments, the emulsifier comprises monoglycerides and diglycerides. In certain embodiments, the emulsifier is Estric™ (available from Bunge). In certain embodiments, the base oil used herein comprises a blend of hydrogenated soybean oil and fully hydrogenated cottonseed oil.

In certain embodiments, the amount of base oil in the composition is about 5-50% by weight based on the total weight of the composition. In certain embodiments, the amount of base oil in the composition is about 5-40%, 10-40%, 20-40%, 15-35%, or 15-30% by weight based on the total weight of the composition.

In certain embodiments, the base oil comprises soybean oil, palm oil, corn oil, sunflower oil, rapeseed oil, peanut oil, safflower oil, high oleic safflower oil, olive oil, cottonseed oil, or a mixture thereof, from about 3-20% by weight based on the total weight of the composition. In certain embodiments, the composition comprises soybean oil from about 3-15%, 3-12% or 5-20% by weight based on the total weight of the composition. In certain embodiments, the amount of soybean oil in the composition is about 3, 5, 7, 8, 9, 10, 11, 12, 13, 14, 15, 16, 17, 18, 19 or 20% by weight based on the total weight of the composition.

In certain embodiments, the base oil comprises an oil blend comprising palm oil and soybean oil. In certain embodiments, the base oil is an oil blend comprising palm oil, palm stearin, soybean oil, and Estric™ (available from Bunge). In certain embodiments, the amount of the oil blend in the composition is about 15, 17, 19, 23, 25, 27, 36 or 40% by weight based on the total weight of the composition. In certain embodiments, the amount of soybean oil in the oil blend is about 10-30% by weight based on the total weight of the oil blend. In certain embodiments, the amount of soybean oil in the oil blend is about 10-20% by weight based on the total weight of the oil blend. In certain embodiments, the amount of soybean oil in the soybean and palm oil blend is about 10, 13, 15, 18, 20, 22, 24, 25, 27 or 30% by weight based on the total weight of the oil blend. In certain embodiments, the amount of palm oil in the oil blend is about 60-95% by weight based on the total weight of the oil blend. In certain embodiments, the amount of palm oil in the oil blend is about 60, 65, 69, 70, 75, 77, 80, 82, 84, 86, 88, 90, 92 or 95% by weight based on the total weight of the oil blend. In certain embodiments, the amount of palm stearin in the oil blend is about 10-25% by weight based on the total weight of the oil blend. In certain embodiments, the amount of palm stearin in the oil blend is about 10, 12, 15, 17, 20, 23, or 25% by weight based on the total weight of the oil blend. In certain embodiments, the oil blend further comprises an emulsifier, such as Estrin™, in an amount from about 0.5-3%, 0.5-2%, 0.5-1% or about 1% by weight based on the total weight of the oil blend.

In certain embodiments, the compositions provided herein further comprise one or more additives. Common additives that can be added to the shortening compositions provided herein include, but are not limited to stabilizers, flavoring agents, emulsifiers, anti-spattering agents, colorants, or antioxidants. Exemplary additives are described, for example, in Campbell et al., Food Fats and Oils, 8th Ed., Institute of Shortening and Edible Oils, Washington, D.C.

In certain embodiments, the compositions further comprise a preservative or an antioxidant. A wide variety of preservatives and antioxidants are suitable for use, including but not limited to butylated hydroxytoluene (BHT), butylated hydroxyanisole (BHA), tertiary butylhydroquinone (TBHQ), ethylenediaminetetracetic acid (EDTA), potassium sorbate, gallate esters (i.e. propyl gallate, butyl gallate, octyl gallate, dodecyl gallate, etc.), tocopherols, lactic acid, citric acid, citric acid esters (i.e. isopropyl citrate, etc.), gum guaiac, nordihydroguaiaretic acid (NDGA), thiodipropionic acid, ascorbic acid, ascorbic acid esters (i.e. ascorbyl palmitate, ascorbyl oleate, ascorbyl stearate, etc.) tartaric acid, lecithin, methyl silicone, sodium benzoate, polymeric antioxidant (Anoxomer) plant (or spice and herb) extracts (i.e. rosemary, sage, oregano, thyme, marjoram, etc.) and mixtures thereof. In certain embodiments, preservatives and antioxidants include but not limited to butylated hydroxytoluene (BHT), butylated hydroxyanisole (BHA), tertiary butylhydroquinone (TBHQ), ethylenediaminetetracetic acid (EDTA), gallate esters (i.e. propyl gallate, butyl gallate, octyl gallate, dodecyl gallate, etc.), tocopherols, lactic acid, citric acid, citric acid esters (i.e. isopropyl citrate, etc.), gum guaiac, nordihydroguaiaretic acid (NDGA), thiodipropionic acid, ascorbic acid, ascorbic acid esters (i.e. ascorbyl palmitate, ascorbyl oleate, ascorbyl stearate, etc.) tartaric acid, lecithin, methyl silicone, sodium benzoate, polymeric antioxidant (Anoxomer) plant (or spice and herb) extracts (i.e. rosemary, sage, oregano, thyme, marjoram, etc.) and mixtures thereof.

In certain embodiments, the spread formulations further comprise an emulsifier. A wide variety of emulsifiers are suitable for use, including but not limited to mono- and diglycerides, distilled monoglycerides, polyglycerol esters of C₁₂ to C₂₂ fatty acids, propylene glycol mono and diesters of C₁₂ to C₂₂ fatty acids, sucrose mono- and diesters of C₁₄ to C₂₂ fatty acids. In certain embodiments, the emulsifier is selected from triglyceryl monoshortening, for example, POLYALDO® TGMSH (from Lonza Inc.), lecithin and combination thereof. In certain embodiments, the compositions comprise from about 0.5% to 5.0% POLYALDO® TGMSH based on total weight of the composition. In certain embodiments, the compositions comprise from about 1% to 3% POLYALDO® TGMSH based on total weight of the composition. In certain embodiments, the compositions comprise about 1% or 2.65% POLYALDO® TGMSH based on total weight of the composition. In certain embodiments, the compositions comprise from about 0.1% to 2% lecithin based on total weight of the composition. In certain embodiments, the compositions comprise from about 0.25% to 1.5% lecithin based on total weight of the composition. In certain embodiments, the compositions comprise about 0.25%, 0.5% or 1% lecithin based on total weight of the composition. In certain embodiments, the compositions comprise about 0.25% to about 1.5% lecithin and about 1 to about 3% POLYALDO® TGMSH based on total weight of the composition. In certain embodiments, the compositions comprise about 0.5% lecithin and about 2.65% POLYALDO® TGMSH based on total weight of the composition.

In certain embodiments, the spread formulations further comprise an anti-molding agent, such as potassium sorbate. In certain embodiments, the anti-molding agent in the compositions is from about 0.05% to about 0.2% based on total weight of the composition. In certain embodiments, the anti-molding agent in the compositions is from about 0.05% to about 0.15% based on total weight of the composition. In certain embodiments, the anti-molding agent in the compositions is about 0.05%, 0.75%, 0.1%, 0.15% or 0.2% based on total weight of the composition.

In certain embodiments, the spread formulations further comprise additional ingredients, such as salt, coloring and flavoring agents. In certain embodiments the flavoring agents include butter flavoring agents, meat flavoring agents, tallow flavoring agents, olive oil flavoring agents and other natural or synthetic flavoring agents. In certain embodiments, vitamins can be included in the compositions provided herein. In certain embodiments, various other additives can be used in the spread compositions provided that they are edible and aesthetically desirable.

In certain embodiments, the spread compositions provided herein comprise about 40-55% water, 7-20% seeding agent, 3-6% cellulose fiber, 10-50% base oil, and remaining amount of additives based on the total weight of the composition.

In certain embodiments, the spread compositions provided herein comprise about 40-55% water, 7-20% seeding agent, 3-6% cellulose fiber, 10-28% oil blend comprising palm and soybean oil, 3-20% soybean oil and remaining amount of additives based on the total weight of the composition.

In certain embodiments, the spread compositions provided herein comprise about 40-55% water, 7-20% seeding agent, 3-6% cellulose fiber, 10-28% oil blend, 3-20% soybean oil and remaining amount of additives based on the total weight of the composition.

In certain embodiments, the spread compositions provided herein comprise about 55% water, 8% seeding agent, 5% cellulose fiber, 22% oil blend, 5% soybean oil and remaining amount of additives based on the total weight of the composition.

In certain embodiments, the spread compositions provided herein comprise about 55% water, 10% seeding agent, 5% cellulose fiber, 18% oil blend, 7% soybean oil and remaining amount of additives based on the total weight of the composition.

In certain embodiments, the spread compositions provided herein comprise about 45% water, 9% seeding agent, 5% cellulose fiber, 24% oil blend, 12% soybean oil and remaining amount of additives based on the total weight of the composition.

In certain embodiments, the spread compositions provided herein comprise about 56% water, 15% seeding agent, 5% cellulose fiber, 16% oil blend, 3% soybean oil and remaining amount of additives based on the total weight of the composition.

In certain embodiments, the spread compositions provided herein comprise about 53% water, 17% seeding agent, 5% cellulose fiber, 12% oil blend, 7% soybean oil and remaining amount of additives based on the total weight of the composition.

In certain embodiments, the spread compositions provided herein comprise about 53% water, 17% seeding agent, 5% cellulose fiber, 12% oil blend, 7% soybean oil and remaining amount of additives based on the total weight of the composition.

Methods of Preparation

Starting materials used in preparing the compositions provided herein are either known or can be prepared according to known methods.

In certain embodiments, the methods of preparation comprise the steps of mixing a seeding agent with a base oil to obtain an oil mixture, mixing cellulose with the oil mixture to obtain an oil-fiber blend, adding an aqueous phase to the oil-fiber blend, mixing to obtain a homogeneous composition, and cooling. In one embodiment, the homogeneous composition is cooled with agitation in a bench top crystallizer, to promote a crystal structure that imparts the desired physical properties to the composition.

The order of adding the ingredients and heating the ingredients can be changed as required by a particular process. In certain embodiments, the oil mixture and cellulose fiber are mixed at about 50-80° C. In certain embodiments, the oil-fiber blend and aqueous phase are mixed at about 50-80° C. It is intended that the claims appended hereto shall not be limited by the order of the heating and mixing steps.

In one embodiment, provided herein is a method for preparing the spread composition, wherein the method comprises a) mixing a seeding agent with a base oil (e.g. soybean oil and oil blend comprising palm and soybean oil) to obtain an oil mixture b) blending together the oil mixture and a cellulose fiber to obtain an oil-fiber blend, and c) mixing an aqueous phase in the oil-fiber blend to obtain a homogeneous composition. In certain embodiments, steps a), b) and/or c) are carried out at a temperature of about 50-80° C., 55-75° C., 60-75° C. or 60-70° C. In certain embodiments, the mixing step c) is followed by cooling, optionally with agitation, to obtain a solidified composition. In certain embodiments, the cooling is performed at freezing temperatures. In certain embodiments, the cooling is performed at a temperature of about 25° C., 20° C., 15° C., 10° C., 5° C., 0° C., −5° C. or lower. In certain embodiments, the cooling is performed at a temperature of about 25° C.-10° C., 25° C.-15° C., or 22° C.-18° C. In certain embodiments, the cooling is performed in a bench top crystallizer. In certain embodiments, the cooling is performed with agitation to obtain a solidified composition.

In certain embodiments, a mechanical agitator is used to obtain the mixture in step a) the oil-fiber blend in step b) and/or the homogeneous composition in step c). In one embodiment, in step b), the agitation is carried out till the cellulose fiber disperses into the oil. In certain embodiments, step a) is started at room temperature and the oil is heated up to a temperature of about 45, 50, 53, 55, 57, 59, 61, 63, 65, 67, 70, 73 or 75° C. while mixing. In certain embodiments, cellulose fiber is added to the oil mixture at about 45, 50, 53, 55, 57, 59, 61, 63, 65, 67, 70, 73 or 75° C. In certain embodiments, the blend is mixed for about 3-15 minutes, or 3-10 minutes.

In another embodiment, the method comprises a) blending together one or more base oils and a seeding agent to obtain an oil-ester blend, and b) mixing cellulose fiber with the oil-ester blend to obtain an oil phase. In certain embodiments, steps a) and b) are carried out at a temperature of about 40-95° C., 50-75° C., 50-70° C., 60-75° C. or 60-70° C.

The mixing of the cellulose fiber and base oils can be accomplished using techniques known in the art.

The seeding agent can be prepared using techniques known in the art, for example, by chemically catalyzed conversion of triacylglycerol (fully hydrogenated palm) into diacylglycerols represented by the following equation:

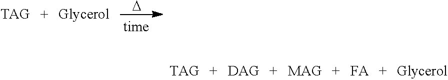

In one embodiment, the starting raw material (i.e. palm, palm stearine, behenic FFA, soy, canola, hear oil and other various oil and FFA blends) is heated to a temperature of about 120-150° C.; about 3-5% by weight glycerin is added while heating is continued. About 0.2% by weight (CaOH)₂ powder is added at 165° C. and reaction continued for about 90 minutes within a temperature range of about 165° C.-175° C. The reaction mixture is cooled to about 125° C.-130° C., and about 0.375% by weight of 85% phosphoric acid is added with mixing to neutralize. Mixing is continued for about 10 minutes, and about 0.5% by weight each of Trisyl and filter aid are added with mixing. The mixture is filtered after about 10 minutes. In certain embodiments, the filtered material is deodorized for 4 hours using techniques known in the art.

In one embodiment, the mixture is continuously sparged with nitrogen and agitating at approximately 450-600 rpm throughout the reaction, neutralization and post-treatment process.

The spread compositions produced herein can be used to produce a variety of foods including, but not limited to, cakes, icings, breads, brownies, pie crusts, croissants, cookies or pastry puffs. With the reduction in total saturated and trans fat content, food products produced with the compositions described herein can provide health benefits.

The following examples present certain exemplary embodiments and are intended by way of illustration and not by way of limitation. In each of the examples herein, percentages indicate weight percent of the total mixture, unless otherwise indicated.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of the claimed subject matter. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

### Examples 1-37

The compositions of Examples 1-37 described in Table 1 were prepared using the following general procedure:

The seeding agent used in Examples 1-37 was prepared according to the procedure described in Example 38. The oil blend used in Examples 1-2 contained 87.5% partially hydrogenated soybean oil and 12.5% fully hydrogenated cottonseed oil. The oil blend used in Examples 3-37 contained 69% palm oil, 17% palm stearin, 13% soybean oil, and 1% Estric™ (available from Bunge).

Various additives used in examples are commercially available, for example, Vitamin A color premix is available from Vitamins Inc., Butter flavor is available from Abelei Inc., and PGE POLYALDO® is available from Lonza Inc.

The cellulose fiber used in the examples is CREAFIBE QC 40.

The desired amounts of all oil phase ingredients, except cellulose, were weighed and mixed in a beaker. The desired amounts of aqueous phase ingredients were weighed and mixed in a separate beaker. Both the oil and aqueous phases were heated up to about 60° C.-70° C. The desired amount of cellulosic fibrous material was added to the fully melted oil phase ingredients being held at 60° C.-70° C. The mixture was stirred via a magnetic stirrer for about 2-4 minutes. The aqueous phase was added to the oil phase and stirred for another 2-4 minutes. The mixture containing oil and aqueous phases was poured into a stainless steel beaker and sheared at 4600-5100 rpm for 1-2 minutes.

The mixture was poured into frozen CUISINART® ICE 21 bench top crystallizer frozen bowl and churned for 5-15 minutes. Sample were scooped out of bowl and placed in glass jars and allowed to stay at ambient temperature for 24 hours prior to evaluation of any oiling/watering out and spreadability.

TABLE 1

| | Oil Phase | | | | | Aqueous phase | | | | |
|---|---|---|---|---|---|---|---|---|---|---|
| | | | | | PEG | | | | Vitamin | Butter |
| Example | Soybean | Seeding | Cellulose | Oil blend | Polyaldo ® | Water | Salt | EDTA | A color | flavor |
| No. | oil (%) | agent (%) | (%) | (%) | (%) | (%) | (%) | (%) | premix (%) | (%) |
| 1.¹ | 10.00 | 12.00 | 5.00 | 18 | — | 53.29 | 1.00 | — | — | 0.069 |
| 2.² | 30.00 | 10.00 | 5.00 | 10 | — | 42.99 | 1.00 | — | — | 0.069 |
| 3. | 10.00 | 15.00 | 10.00 | 30.00 | — | 32.00 | 2.90 | 0.01 | 0.02 | 0.07 |
| 4. | 10.00 | 17.00 | 11.00 | 22.00 | — | 37.00 | 2.90 | 0.01 | 0.02 | 0.07 |
| 5. | 15.00 | 10.00 | 10.00 | 22.00 | — | 40.00 | 2.90 | 0.01 | 0.02 | 0.07 |
| 6. | 15.00 | 10.00 | 7.00 | 22.00 | — | 40.00 | 2.90 | 0.01 | 0.02 | 0.07 |
| 7. | 15.00 | 10.00 | 5.00 | 22.00 | 1.00 | 44.00 | 2.90 | 0.01 | 0.02 | 0.07 |
| 8. | 12.00 | 7.00 | 5.00 | 35.00 | 1.00 | 37.00 | 2.90 | 0.01 | 0.02 | 0.07 |
| 9. | 5.00 | 7.00 | 5.00 | 42.00 | 1.00 | 37.00 | 2.90 | 0.01 | 0.02 | 0.07 |
| 10. | 0.00 | 5.00 | 5.00 | 49.00 | 1.00 | 37.00 | 2.90 | 0.01 | 0.02 | 0.07 |
| 11. | 0.00 | 5.00 | 5.00 | 52.00 | 1.00 | 34.00 | 2.90 | 0.01 | 0.02 | 0.07 |
| 12. | 0.00 | 5.00 | 5.00 | 26.00 | 1.00 | 60.00 | 2.90 | 0.01 | 0.02 | 0.07 |
| 13. | 17.00 | 3.00 | 5.00 | 25.00 | 1.00 | 46.00 | 2.90 | 0.01 | 0.02 | 0.07 |
| 14. | 10.00 | 4.00 | 6.50 | 27.00 | 2.00 | 47.50 | 2.90 | 0.01 | 0.02 | 0.07 |
| 15. | 7.00 | 5.00 | 6.50 | 28.00 | 2.00 | 48.50 | 2.90 | 0.01 | 0.02 | 0.07 |
| 16. | 3.00 | 5.00 | 6.50 | 28.00 | 2.00 | 52.50 | 2.90 | 0.01 | 0.02 | 0.07 |
| 17. | 0.00 | 5.00 | 7.00 | 28.00 | 2.00 | 55.00 | 2.90 | 0.01 | 0.02 | 0.07 |
| 18. | 5.00 | 8.00 | 7.00 | 22.00 | 2.00 | 53.00 | 2.90 | 0.01 | 0.02 | 0.07 |
| 19. | 7.00 | 10.00 | 7.00 | 18.00 | 2.00 | 53.00 | 2.90 | 0.01 | 0.02 | 0.07 |
| 20. | 5.00 | 8.00 | 5.00 | 22.00 | 2.00 | 55.00 | 2.90 | 0.01 | 0.02 | 0.07 |
| 21. | 7.00 | 10.00 | 5.00 | 18.00 | 2.00 | 55.00 | 2.90 | 0.01 | 0.02 | 0.07 |
| 22. | 8.00 | 10.00 | 5.00 | 22.00 | 2.00 | 50.00 | 2.90 | 0.01 | 0.02 | 0.07 |
| 23. | 10.00 | 6.00 | 5.00 | 27.00 | 2.00 | 47.00 | 2.90 | 0.01 | 0.02 | 0.07 |
| 24. | 3.00 | 15.00 | 5.00 | 16.00 | 2.00 | 56.00 | 2.90 | 0.01 | 0.02 | 0.07 |
| 25. | 6.00 | 10.00 | 5.00 | 24.00 | 2.00 | 50.00 | 2.90 | 0.01 | 0.02 | 0.07 |
| 26. | 7.00 | 6.00 | 5.00 | 28.00 | 2.00 | 49.00 | 2.90 | 0.01 | 0.02 | 0.07 |
| 27. | 5.00 | 6.00 | 5.00 | 30.00 | 2.00 | 49.00 | 2.90 | 0.01 | 0.02 | 0.07 |
| 28. | 3.00 | 12.00 | 5.00 | 16.00 | 2.00 | 59.00 | 2.90 | 0.01 | 0.02 | 0.07 |
| 29. | 15.00 | 8.00 | 5.00 | 22.00 | 2.00 | 45.00 | 2.90 | 0.01 | 0.02 | 0.07 |
| 30. | 3.00 | 15.00 | 3.00 | 16.00 | 2.00 | 58.00 | 2.90 | 0.01 | 0.02 | 0.07 |
| 31. | 3.00 | 8.00 | 5.00 | 30.00 | 2.00 | 49.00 | 2.90 | 0.01 | 0.02 | 0.07 |
| 32. | 12.00 | 9.00 | 5.00 | 24.00 | 2.00 | 45.00 | 2.90 | 0.01 | 0.02 | 0.07 |
| 33. | 5.00 | 15.00 | 5.00 | 14.00 | 2.00 | 56.00 | 2.90 | 0.01 | 0.02 | 0.07 |
| 34. | 0.00 | 15.00 | 5.00 | 18.00 | 2.00 | 57.00 | 2.90 | 0.01 | 0.02 | 0.07 |
| 35. ³ | 3.00 | 15.00 | 5.00 | 16.00 | 2.00 | 55.86 | 2.90 | 0.01 | 0.02 | 0.07 |
| 36. ³ | 10.00 | 19.00 | 5.00 | 9.00 | 2.00 | 51.648 | 3.10 | 0.01 | 0.02 | 0.07 |
| 37. | 7.00 | 19.00 | 5.00 | 12.00 | 2.00 | 51.00 | 3.10 | 0.01 | 0.02 | 0.07 |

¹In Example 1, the oil phase also contained distilled mono and diglycerides (0.29%), soybean lecithin (0.20%), vitamin A palmitate (0.0028%), beta-carotene (0.0020%). The aqueous phase contained sodium benzoate (0.100%) and lactic acid (0.05%).
²In Example 2, the oil phase also contained distilled mono and diglycerides (0.29%), soybean lecithin (0.50%), vitamin A palmitate (0.0028%), beta-carotene (0.0020%). The aqueous phase contained sodium benzoate (0.100%) and lactic acid (0.05%).
³ In Examples 35 and 36, the aqueous phase additionally contained sodium benzoate (0.10%) and lactic acid (0.05%).

### Example 38

The seeding agent used in the compositions of Examples 1-37 described in Table 1 was prepared using the following general procedure. The starting raw material used in this particular example was palm oil. Other oils, including, but not limited to palm stearine, behenic FFA, soybean oil, canola oil, hear oil and FFA blends can be used in a similar reaction.

A 3-neck glass reaction vessel was charged with the starting raw material. The oil was heated to a temperature of 140° C. About 4% by weight glycerin was added and heating was continued till the temperature reached 165° C. The reaction mixture was continuously sparged with nitrogen and agitated at approximately 450-600 rpm throughout the reaction, neutralization and post-treatment process.

About 0.2% by weight (CaOH)₂ powder was added at 165° C. and reaction continued for 90 minutes within a temperature range of 165° C.-175° C. The mixture was cooled to 125° C.-130° C. and about 0.375% by weight of 85% conc. phosphoric acid was added to neutralize. Mixing was continued for 10 minutes. About 0.5% by weight each of trisyl and filter aid were added; mixing was continued for 10 minutes. The product was recovered by filtration, and filtered material was then deodorized for 4 hours at 226°-232° C. and 0.114-0.870 mbar.

### Example 39

A spread composition similar to the composition of Example 35 was prepared using a blend of commercial TAGs, DAGs and MAGs instead of the seeding agent described in Example 37. The blend of commercial esters was prepared with: 52% Fully hydrogenated palm, 42% TRANCENDIM® and 6% BFP® 65 Palm. The spread composition was prepared using the general procedure as described above for Examples 1-37, and allowed to sit for 24 hours before evaluation.

### Example 40

A comparison of the compositions of Example 35 and 39 indicated that the composition of Example 39 was softer in comparison to compositions made with the seeding agent (Example 35) and had a texture that tended to spread yet lump. The composition with the seeding agent (Example 35) had a smoother creamier texture and appearance.

### Example 41

The following compositions were prepared in a pilot plant on a 10 pound scale using a procedure described for Example 1-35. The oil blend contained 69% palm oil, 17% palm stearin, 13% soybean oil, and 1% Estric™ (available from Bunge).

### Example 41A

| Ingredient Name | % in Formula |
|---|---|
| Oil Phase | |
| Oil blend | 22.0000 |
| Seeding Agent | 8.0000 |
| Soybean Oil | 5.0000 |
| Cellulose Fiber | 5.0000 |
| PGE Polyaldo | 2.0000 |
| Aqueous Phase | |
| Water | 54.8600 |
| Salt | 2.9000 |
| Sodium Benzoate | 0.1000 |
| Butter Flavor | 0.0700 |
| Lactic Acid | 0.0500 |
| Vitamin A, Color Premix | 0.0200 |

### Example 41B

| Ingredient Name | % in Formula |
|---|---|
| Oil Phase | |
| Palm and soybean blend | 18.0000 |
| Seeding Agent | 10.0000 |
| Soybean Oil | 7.0000 |
| Cellulose Fiber | 5.0000 |
| PGE Polyaldo | 2.0000 |
| Aqueous Phase | |
| Water | 54.8600 |
| Salt | 2.9000 |
| Sodium Benzoate | 0.1000 |
| Butter Flavor | 0.0700 |
| Lactic Acid | 0.0500 |
| Vitamin A, Color Premix | 0.0200 |

The samples which were 10 lbs mini cubes were placed into the 70° F. and 85° F. temperature control rooms in order to examine the shelf life. In both compositions no signs of oiling out were observed in the 70° F. environment after 3 months while slight oiling out was observed within the first month in the 85° F. environment. Samples were also submitted for microbial analysis. Both of the samples demonstrated microbial stability over the course of three months.

Croissants, chocolate chip cookies, and sugar cookies were prepared using the pilot plant samples and compared with those prepared using Bunge™ NH 500 Baker's margarine. The fat and saturated fat content of the baked goods are shown in Table 2 below.

TABLE 2
Bakery Application Nutritional Data

| | Bunge ™ NH 500 | | | | | | | |
|---|---|---|---|---|---|---|---|---|
| | Baker's margarine | | Example 41A | | | Example 41B | | |
| | | Saturated | | Saturated | Sat. fat | | Saturated | Sat. fat |
| | Fat | Fat | Fat | Fat | Reduction | Fat | Fat | Reduction |
| Croissants | 13.33% | 6.04% | 8.44% | 4.26% | 29.50% | 8.88% | 4.57% | 24.30% |
| Chocolate | 22.60% | 11.19% | 13.48% | 6.67% | 40.40% | 13.73% | 7.51% | 32.90% |
| Chip | | | | | | | | |
| Cookies | | | | | | | | |
| Sugar | 21.22% | 9.62% | 11.22% | 5.43% | 43.60% | 11.83% | 5.92% | 38.50% |
| Cookies | | | | | | | | |

### Example 42

The following compositions were prepared on a 5 pound scale using a procedure described for Example 1-35. The oil blend contained 69% palm oil, 17% palm stearin, 13% soybean oil, and 1% Estric™ (available from Bunge).

### Example 42A

| Ingredient Name | % in Formula |
|---|---|
| Oil Phase | |
| Oil blend | 24.0000 |
| Soybean Oil | 12.0000 |
| Seeding Agent | 9.0000 |
| Cellulose Fiber | 5.0000 |
| PGE Polyaldo | 2.0000 |
| Aqueous Phase | |
| Water | 44.8600 |
| Salt | 2.9000 |
| Sodium Benzoate | 0.1000 |
| Butter Flavor | 0.0700 |
| Lactic Acid | 0.0500 |
| Vitamin A, Color Premix | 0.0200 |

### Example 42B

| Ingredient Name | % in Formula |
|---|---|
| Oil Phase | |
| Oil blend | 16.0000 |
| Seeding Agent | 15.0000 |
| Cellulose Fiber | 5.0000 |
| Soybean Oil | 3.0000 |
| PGE Polyaldo | 2.0000 |
| Aqueous Phase | |
| Water | 55.8600 |
| Salt | 2.9000 |
| Sodium Benzoate | 0.1000 |
| Butter Flavor | 0.0700 |
| Lactic Acid | 0.0500 |
| Vitamin A, Color Premix | 0.0200 |

Cakes, brownies, croissants, and garlic toast were prepared using these samples, and compared with those prepared using Bunge™ NH 500 Baker's margarine. The fat and saturated fat content of the food products are shown in Table 3 below.

TABLE 3
Bakery Application Nutritional Data

| | Bunge ™ NH 500 | | Example 42A | | | Example 42B | | |
|---|---|---|---|---|---|---|---|---|
| | Baker's margarine | | | | Sat. fat | | | Sat. fat |
| | Fat | Sat. | Fat | Saturated | Reduction | Fat | Saturated | Reduction |
| | (%) | Fat (%) | (%) | Fat (%) | (%) | (%) | Fat (%) | (%) |
| Cakes | 11.64 | 5.32 | 6.26 | 2.96 | 44.40 | 4.74 | 2.94 | 44.70 |
| Brownies | 28.39 | 12.68 | 19.74 | 8.81 | 30.52 | 13.81 | 7.89 | 37.78 |
| Croissants | 23.99 | 11.05 | 15.36 | 7.23 | 34.60 | 11.78 | 6.85 | 38.00 |
| Garlic | 17.88 | 7.49 | 12.05 | 6.41 | 14.40 | 12.31 | 6.51 | 13.10 |
| Toast | | | | | | | | |

### Example 43

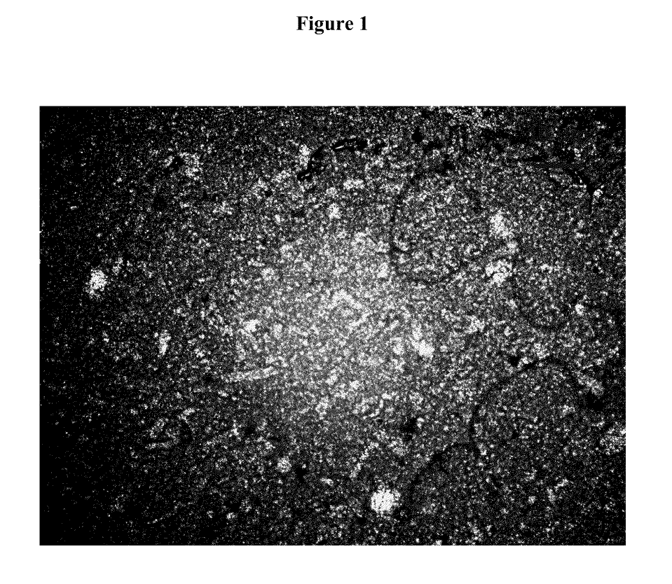

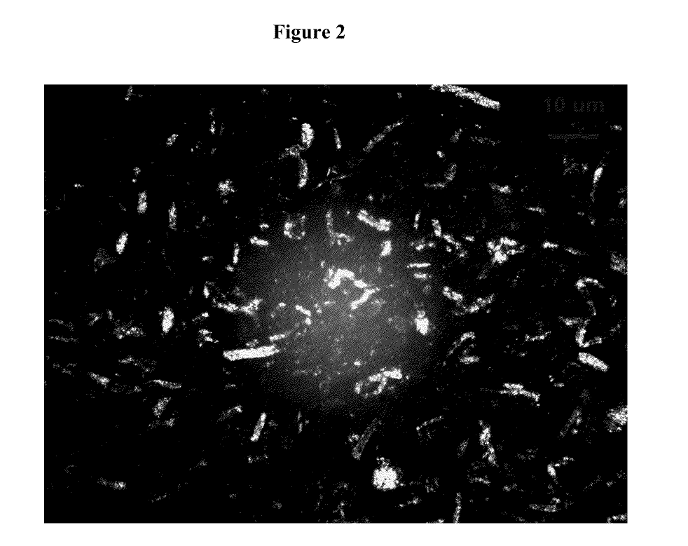

Microscopic images of a sample composition of Example 42B were taken with polarized light, and are provided in FIGS. 1 and 2. The two images show the co-localization of the triglyceride/specialty ester mixture with that of the cellulosic fibrous material within the sample. FIG. 1 utilizing a polarized light source shows a very dense well structured crystal matrix. FIG. 2 is the same sample utilizing a cross polarized light source in order to show the cellulosic fibrous material. The co-localization points are the bright white spots observed in the same regions on both of the images. FIGS. 1 and 2 thus show the synergist relationship between the cellulosic fibrous material and the oil within the spread product.

### Example 44

The following composition was prepared using a procedure described for Example 1-35. The oil blend contained 69% palm oil, 17% palm stearin, 13% soybean oil, and 1% Estric™ (available from Bunge).

### Example 44

| Ingredient Name | % in Formula |
|---|---|
| Oil Phase | |
| Oil Blend | 12.0000 |
| Seeding Agent | 17.0000 |
| Soybean Oil | 7.0000 |
| Cellulose Fiber | 5.0000 |
| PGE Polyaldo | 2.6480 |
| Aqueous Phase | |
| Water | 53.0000 |
| Salt | 3.1000 |
| Sodium Benzoate | 0.1000 |
| Butter Flavor | 0.0700 |
| EDTA | 0.0100 |
| Beta-Carotene | 0.0020 |
| Lactic Acid | 0.0500 |
| Vitamin A, Color Premix | 0.0200 |

Cakes, croissants, pie crusts, icings and sugar cookies were prepared using this composition, and compared with those prepared using Vreamay® NH, Bunge™ NH 500 Baker's margarine and Vream® NH. The fat and saturated fat content of the food products are shown in Table 4 below.

TABLE 4
Bakery Application Nutritional Data

| | Vreamay ® NH | | Bunge ™ 500 NH | | Vream ® NH | | Example 44 | | |
|---|---|---|---|---|---|---|---|---|---|
| | | Saturated | | Saturated | | Saturated | | Saturated | Sat. fat |
| | Fat | Fat | Fat | Fat | Fat | Fat | Fat | Fat | Reduction |
| Cakes | 14.74% | 6.31% | 12.24% | 5.45% | N/A | N/A | 5.92% | 3.44% | 36.88%- |
| | | | | | | | | | 45.48% |
| Croissants | N/A | N/A | 31.92% | 14.30% | N/A | N/A | 16.97% | 9.56% | 33.15% |
| Pie Crust | N/A | N/A | 35.63% | 16.09% | 41.34% | 21.25% | 18.02% | 10.65% | 33.81%- |
| | | | | | | | | | 49.88% |
| Icings | 30.65% | 13.32% | 26.13% | 11.77% | N/A | N/A | 13.21% | 7.77% | 33.98%- |
| | | | | | | | | | 41.67% |
| Sugar | N/A | N/A | 22.26% | 9.92% | 26.67% | 13.55% | 12.15% | 6.95% | 29.94%- |
| Cookies | | | | | | | | | 48.71% |

N/A = not available.

### Example 45

### Effect of Anti-Molding Agent

In this example, the effect of an-molding agent in the aqueous phase was in the compositions. Potassium sorbate was used as the anti-molding agent.

Some samples from the pilot plant formulations were observed to grow mold after storage for approximately two months or more from their manufacturing date. Based on these findings, the aqueous phase for the formulation was modified so to include an anti-molding agent, potassium sorbate.

A margarine composition similar to Example 42B was prepared using the aqueous phase shown in Table 5, for comparison.

TABLE 5
Aqueous phase formulation

| | % in | | |
|---|---|---|---|
| Ingredient Name | Formula | Wt. (in lb) | Kosher |
| Aqueous Phase Ingredients | | | |
| Water | 54.0650 | 60.866 | Y |
| Salt | 3.1000 | 3.490 | Y |
| Sodium Benzoate | 0.1000 | 0.113 | Y |
| Lactic Acid | 0.0500 | 0.056 | Y |
| EDTA | 0.0100 | 0.011 | Y |

After approximately two month after its production date, the formulation showed mold growth. The aqueous phase in Table 5 was modified as shown in Table 6 to incorporate mold growth inhibitor.

TABLE 6
Modified aqueous phase formulation including potassium sorbate

| | % in | Wt. | |
|---|---|---|---|
| Ingredient Name | Formula | (in lb) | Kosher |
| Aqueous Phase Ingredients | | | |
| Water | 53.9900 | 1.080 | Y |
| Salt | 3.1000 | 0.062 | Y |
| Sodium Benzoate | 0.1000 | 0.002 | Y |
| Lactic Acid | 0.0500 | 0.001 | Y |
| EDTA | 0.0100 | 0.000 | Y |
| Potassium sorbate | 0.1000 | 0.002 | Y |

The aqueous phase shown in Table 2 was applied in various formulations containing different fibers and/or emulsifier systems, and no mold growth was observed for up to four months.

### Example 46

### Effect of Emulsifier

The effect of emulsifiers POLYALDO® TGMSH (from Lonza Inc.) and lecithin, independently and in combination, on emulsion stability was observed in this study.

Multiple bench top margarines were formulated by varying ratios of emulsifiers POLYALDO® TGMSH and lecithin. Lecithin was added to the formulation to affect the lipophilic balance imparted by POLYALDO® TGMSH. Two types of cellulose fibers were used in this study, CREAFIBE QC 40 and crystalline cellulose fiber SC 40, Table 7 below provides the ratios of POLYALDO® TGMSH and lecithin emulsifiers, and the type of cellulose fibers that were tested in this study. The other components in the formulations were as described in Table 9. The amount of added emulsifier was compensated for soybean oil in the formulation.

TABLE 7

| Sample | Fiber | POLYALDO ® | |
|---|---|---|---|
| no. | type | TGMSH (%) | lecithin (%) |
| 1A | QC 40 | — | 1.0 |
| 1B | SC 40 | — | 1.0 |
| 2A | QC 40 | 1.0 | 1.0 |
| 2B | SC 40 | 1.0 | 1.0 |
| 3A | QC 40 | — | 0.5 |
| 3B | SC 40 | — | 0.5 |
| 4A | QC 40 | 2.65 | 1.00 |
| 4B | SC 40 | 2.65 | 1.00 |
| 5A | SC 40 | 2.65 | 0.50 |
| 5B | SC 40 | 2.65 | 0.25 |

Table 8 below shows the behavior of the emulsion as observed over time.

TABLE 8
Emulsion Stability While Tempering

| | Fiber | POLYALDO ® | lecithin | | | | | | 120-128 |
|---|---|---|---|---|---|---|---|---|---|
| Sample | type | TGMSH | (%) | <1 day | 1 day | 2 days | 3 days | 7 days | days |
| 1 | QC 40 | — | 1.0 | ENB | ENB | EB | — | — | — |
| 2 | SC 40 | — | 1.0 | ENB | ENB | EB | — | — | — |
| 3 | QC 40 | 1.0 | 1.0 | ENB | WS | WS | ENB | ENB | ENB |
| 4 | SC 40 | 1.0 | 1.0 | ENB | WS | EB | — | — | — |
| 5 | QC 40 | — | 0.5 | EB | — | — | — | — | — |
| 6 | SC 40 | — | 0.5 | ENB | ENB | ENB | ENB | ENB | ENB |
| 7 | QC 40 | 2.65 | 1.00 | ENB | ENB | ENB | EB | — | ENB |
| 8 | SC 40 | 2.65 | 1.00 | ENB | ENB | ENB | ENB | ENB | ENB |
| 9 | SC 40 | 2.65 | 0.50 | ENB | ENB | ENB | ENB | ENB | ENB |
| 10 | SC 40 | 2.65 | 0.25 | ENB | ENB | ENB | WS | EB | ENB |

ENB: Emulsion Not Broken, EB: Emulsion Broken, WS: Water Surfacing

The formulations containing SC 40 fiber and at least 0.5% lecithin appeared to be most stable. The cellulose fiber and emulsifiers of sample no. 9 were selected for further studies.

Table 9 below provides the composition of a formulation prepared using potassium sorbate in the aqueous phase as described in Example 45, and the emulsifiers and cellulose fiber as described in sample 9 of Example 46.

TABLE 9

| Oil Phase Ingredients | |
|---|---|
| Seeding agent | 16.0000 |
| BG D30090-315 PALM | 10.0000 |
| BLEND | |
| Soybean Oil | 8.4950 |
| Cellulose Fiber SC 40 | 5.0000 |
| soybean lecithin | 0.5000 |
| Butter Flavor | 0.0050 |
| POLYALDO ® TGMSH | 2.6500 |
| Aqueous Phase Ingredients | |
| Water | 53.9900 |
| Salt | 3.1000 |
| Sodium Benzoate | 0.1000 |
| Lactic Acid | 0.0500 |
| EDTA | 0.0100 |
| Potassium sorbate | 0.1000 |
| Total | 100.0000 |

This formulation was produced at the pilot plant at 120 lbs scale and used for votation studies. Eight different votation conditions were explored, and for each votation condition a 10 lb mini cube was collected.

After approximately four month from production, all the products (which vary in votation condition but not formulation) remained emulsified and without mold growth. Two of the best votated products were assessed in a small applications study. In this study, sugar cookies and chocolate chip cookies behaved better in terms of flavor and overall product qualities, than cake and brownies.

### Example 47

### Study of Cellulose Fibers

In this example, different cellulose fibers were tested in the formulations. The other components of the formulations were as described in Table 9.

The fibers from different sources wood pulp, cottonseed, and bamboo, as well as different average particle size, and degree of crystallinity were tested. Table 10 provides characteristics of various fibers studied.

TABLE 10

| | | Avg | | Crystallinity | Water |
|---|---|---|---|---|---|
| | | Particle | | Degree (%) | retention |
| Fiber Name | Source | Size (μ) | Supplier | (A₁₃₇₂/A₂₉₀₀) * 100 | (g/100 g) |
| NutraFiber 200 | Wood pulp | 35 | IFC | 30.41 | 300 |
| Just Fiber BF 200 | Bamboo | 35 | IFC | 30.87* | 350 |
| QC 40 | Bamboo | 35 | CreaFill | 37.03 | Unknown |
| Just Fiber BVF 200 | Cottonseed | 40 | IFC | 55.00 | 380 |
| SC 40 | Wood pulp | 40 | CreaFill | 26.75 | Unknown |
| Solka Floc 40 FCC | Wood pulp | 60 | IFC | 31.28* | 550 |

*Fibers with various regions of different degrees of crystallinity (their average being shown in this table)

All the tested fibers led to a product of solid texture with variable graininess. None of these products flowed freely. All products required a scooping action to be placed into jars.

The formulations with fibers NutraFiber 200 and Solka Floc 40 FCC sweated enough water to form a small puddle on top of the product, and some meandering water on the internal sides of the jar, respectively. The water was re-absorbed after two days of tempering, and no breakage of the emulsion was observed over a week after its production.

The SSM formulation containing Just Fiber BVF 200, initially released some small water drops on the surface of the product, but these were re-absorbed on the first day of tempering. The formulation containing Just Fiber BF 200 did not release water at any point in which it was observed. Both formulations remained in emulsified state.

All fibers studied led to a product that remained emulsified; however, some of these fibers had an initial water release or sweating, which was naturally corrected by its re-absorption. The fact that the water was re-absorbed and the margarine remained in solid phase and emulsified is promising, and leads to believe that minor adjustments to the current formulation will correct the initial sweating of the product, if one of these fibers is used to replace SC 40 in Example 46.

Effect of Fiber Length: The formulations with Nutra Fiber 200 (35μ), Just Fiber BVF 200 (40μ), QC 40 (40μ) and, Solka Floc 40 FCC (60μ), had an initial water release (not seen with SC 40, 40μ), which was reabsorbed forming a stable emulsion.

Fiber Source: Nutra Fiber 200, Solka Floc 40 FCC, and SC 40 originate from powdered cellulose. Just Fiber BVF 200 originates from cottonseed, while Just Fiber BF 200 and QC 40 fibers are sourced from bamboo.

All source materials tested in this experiment had performed well with the current formulation. Fibers Just Fiber BF 200 (35μ) and QC 40 (40μ) have the same source and similar particle size, but behave differently (one remains emulsified, while the other leads to the breaking of the emulsion). Therefore in certain embodiments, the source of the fiber might not have a significant role on the ability to remain in an emulsified state.

The fibers SC 40 and Just Fiber BVF 200 (˜27 and 55% degree of crystallinity, respectively) yielded products that were comparable. Although, as previously mentioned, the formulation with Just Fiber BVF 200 led to initial sweating of the product, this was quickly re-absorbed and the emulsion did not separate into its respective phases. In contrast, the formulation containing QC 40 (37.03% degree of crystallinity) led to a quick separation of the product into an aqueous and a solid phase.

Fibers Solka Floc 40 FCC and Just Fiber BF 200 were found to have at least three distinct regions in which the degree of crystallinity drastically varied, therefore limiting the ability to determine an average degree of crystallinity. These fibers, although uneven in their composition, led to formulations that remained emulsified.

Fibers Nutra Fiber 200 and Just Fiber BF 200, had crystallinity degrees of 30.41 and 30.87%, respectively. The formulation with Nutra Fiber 200 initially released water, while the formulation with Just Fiber BF 200 did not.

From the experiments described in this study, in certain embodiments, the degree of crystallinity of the fiber was insufficient to predict whether the margarine would remain in an emulsion form or not.

The bench top margarines produced utilizing different fibers, were measured with the Texture Analyzer in terms of a cone-to-cone spreadability study. The force required to spread a fixed volume of margarine was recorded, and shown in Table 11.

TABLE 11
Cone-to-cone spreadability study of formulations with various fibers

| | | | 1 week tempering | |
|---|---|---|---|---|
| | Length | Crystallinity | Cone-to-cone spreadability | |
| Fiber | (μ) | Degree (%) | (g) | Temp (F.) |
| NutraFiber 200 | 35 | 30.41 | 3553.6 | 67.0 |
| Just Fiber BF 200 | 35 | 30.87* | 4546.9 | 65.7 |
| QC 40 | 40 | 37.03 | Emulsion broken after | |
| | | | 3 hours | |
| Just Fiber BVF 200 | 40 | 55.00 | 4511.8 | 65.7 |
| SC 40 | 40 | 26.75 | 4665.7 | 66.6 |
| Solka Floc 40 FCC | 60 | 31.28* | 3750.1 | 66.6 |

*Fibers with various regions of different degrees of crystallinity (their average being shown in this table)

As seen in Table 11, the bench top margarines formulated with Just Fiber BF 200, Just Fiber BVF 200, and SC 40 had similar characteristics in terms of texture. It is noted that each one of these fibers has a different source (bamboo, cottonseed, and wood pulp, respectively), different crystallinity degree (˜31, 55, and 27%, respectively), but similar particle size (35, 40, 40μ, respectively).

The bench top margarines formulated with NutraFiber 200 and Solka Floc 40 FCC, had also similar measurements in terms of a cone-to-cone spreadability study. These fibers were both comprised of powdered cellulose, had a similar degree of crystallinity (30.41 and 31.28%, but were different in average particle size (35 and 60μ, respectively).

### Example 48

### Optimization of Reaction Conditions for Production of the Seeding Agent

In this example, the reaction conditions for production of the seeding agent described in Example 38 were optimized with respect to reaction time, concentration of diacylglycerol in the reaction product, post-reaction filtration process, and characterization of the triacylglycerol profile of the triacylglycerol species present in the product.

When reaction conditions similar to the ones described in Example 38, except 0.125% (w/w) Ca(OH)₂ catalyst, were used, the range of diacylglycerol produced with these conditions, varied from 30 to 40%, depending on the lot of fully hydrogenated palm used, and human error.

The following reaction conditions were used in the optimization study:
Reagents: Fully hydrogenated palm oil (1200 g), glycerin
Catalyst: Ca(OH)₂ powder (ACS grade ≧95% purity)
Reaction Temperature Range 165° C.-175° C. (329° F.-347° F.)
Reaction Time: See Table 1
Neutralization: 0.2% (weight per weight. w/w) of 85% phosphoric acid, for ˜10 min @ 130° C.
Filtration: Cool down to 115° C., and treat with (0.5% (w/w)) Trisyl S-615 and (0.5% (w/w)) filter Aid. Mix for 10 minutes, and filter using vacuum filtration.

Deodorization Conditions:

Temperature: Range 226.7°-232.2° C. (440.1°-450.0° F.

Vacuum: Range 0.114-0.870 mbar

Time: 4 hours

The reactions were performed at the bench, utilizing suitable glassware.

Four reactions (R1-R4) were conducted over a period of 4 hours, and aliquots of the reaction product were taken at 30 minute intervals. The reaction conditions assessed are shown in Table 12. The catalyst used in reactions R1, R2 and R3 was 0.2% (w/w) Ca(OH)₂ and 0.05% (w/w) Ca(OH)₂ in R4.

Reactions R1 and R2, as well as R3 and R4, were run in parallel. Aliquots were collected every 30 minutes, and the aliquots were submitted for analysis. After completion of 4 hours of reaction time, the product was quenched with 85% H₃PO₄, filtered, and stored for further deodorization.

In addition, reaction R5, was performed in order to explore a different raw material, palm Stearin (Palsgaard 6118). For this reaction, reaction conditions described in Example 38, with 0.125% (w/w) Ca(OH)₂ were employed.

TABLE 12
Reaction Conditions Studied

| | Reaction | | | | |
|---|---|---|---|---|---|
| Reagents | R1 | R2 | R3 | R4 | R5 |
| Glycerin | 4% (w/w) | 4% (w/w) | 2% | 2% | 4% |
| | | | (w/w) | (w/w) | (w/w) |
| Fully Hydrogenated | 1200 g | 1200 g | 1200 g | 1200 g | 0 |
| Palm Oil | | | | | |
| Ca(OH)₂ catalyst | 0.2* | 0.2* | 0.2* | 0.05* | 0.125* |
| Palsgaard 6118 | 0 | 0 | 0 | 0 | 1200 g |
| Time | 4 h | 4 h | 4 h | 4 h | 1.5 h |
| N₂ | Sparge | Blanket | Sparge | Sparge | Sparge |

*% weight of (glycerin % fully hydrogenated palm oil)

Results

A. Effect of N₂ Flow

Reactions R1 and R2 compared the effect of continuous N₂ flow into the reaction mixture, versus the use of a N₂ blanket. The flow of N₂ was supplied by a sparge which was kept flowing at a constant rate throughout the process.

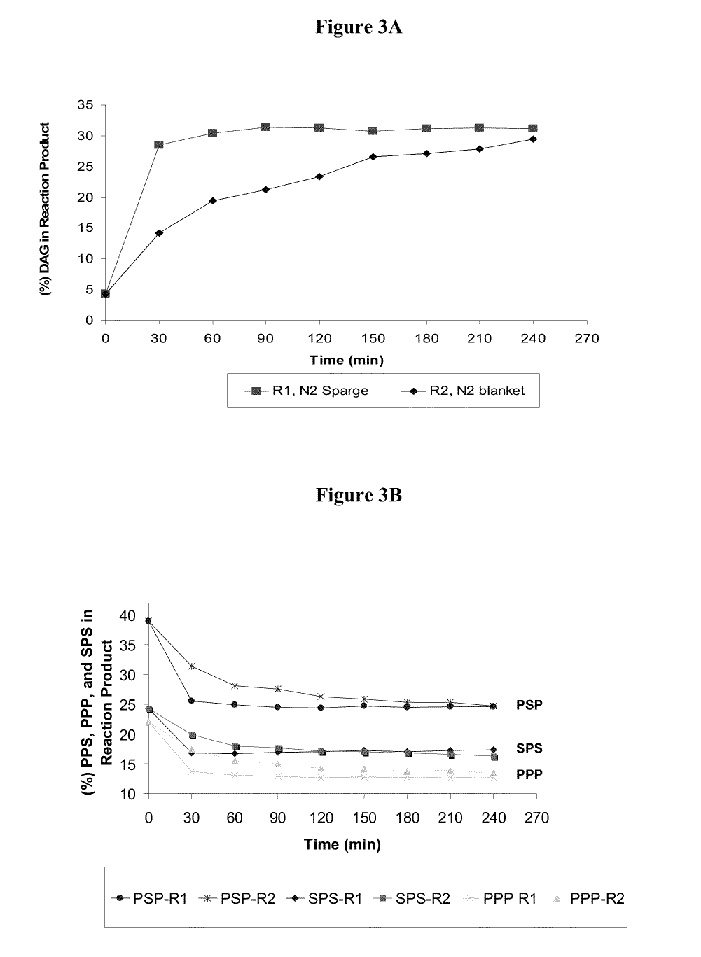

From FIG. 3A, it is seen that the use of a N₂ sparge led to an increased production of DAG in the reaction product. Utilizing a N₂ sparge (R1), the DAG produced reached equilibrium at 60 minutes of reaction time (30.40% DAG in the product).

For the same reaction conditions, utilizing a N₂ blanket (R2), the highest amount of DAG produced (29.40%) was obtained at 240 minutes of reaction time. Based on these observations, it is apparent that the agitation provided by the flow of N₂ in the reaction system, leads to a higher rate of DAG synthesis.

FIG. 3B illustrates major changes observed in the TAG profile of the TAG component present in the reaction product (as reported elsewhere, the product is comprised of TAG, DAG, MAG and FFA).

The original contents of PSP, SPS, and PPP in the physical blend of fully hydrogenated palm and glycerin (˜38.9, 24.3, and 22.0%, respectively) decreased in both, R1 and R2, reactions. The use of N₂ sparge (R1) led to more pronounced differences from the original reagent in terms of PSP, SPS, and PPP content, than the use of N₂ blanket conditions. At 60 minutes of reaction time, reaction R1 led to a decrease in PSP, SPS, and PPP of ˜36, 31, and 40%, respectively. These correspond to a content of ˜25, 17, and 13% PSP, SPS, and PPP in the TAG component of the reaction mixture. Based on this change in TAG profile, it is seen that the fully hydrogenated palm has been rearranged, therefore leading to a TAG different than that observed in the fully hydrogenated reagent.

B. Effect of Lower Glycerin Content

The objective of this experiment was to observe if a reduction in glycerin concentration would lead to a similar DAG content, than observed in the product from R1. Trisil and Filter Aid, when exposed to glycerin, form a colloidal cake that impedes filtration of the reaction product in a timely fashion.

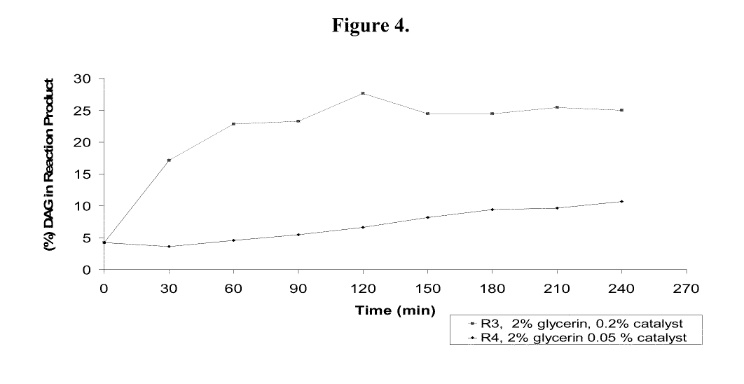

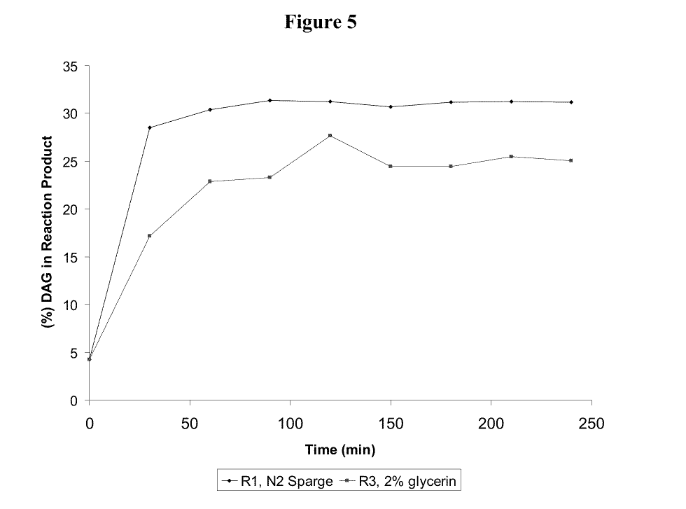

Reactions R3 and R4 (2% (w/w) glycerin) compare the use of catalyst at two different concentrations, over time. From FIG. 3, it is seen that at 0.2% (w/w) catalyst concentration (R3), the content of DAG in the reaction product is larger than at 0.05% (w/w) catalyst (R4). However, comparing reactions R1 and R3, FIG. 4, it is seen that at 2% (w/w) glycerin content the yield of DAG produced (˜25% at equilibrium, 150 minutes) was lower than with 4% (w/w) glycerin content (˜31% at equilibrium, 60 minutes).

In agreement with reactions R1 and R2, the TAG profile of the TAG component of reaction R3, showed a lower content of PSP, SPS, and PPP than the original fully hydrogenated palm oil. At equilibrium (24.5% DAG, 150 min), the reduction of PSP, SPS, and PPP was of ˜24, 20, and 27%, respectively. This change in TAG profile corroborates that the TAG present in the reaction mixture is no longer the fully hydrogenated palm oil used as a reagent.

For reaction R4 (lower use of catalyst), the TAG profile showed a lower reduction in the PPP, PSP, and SPS forms (˜11% each, at 240 minutes), than reaction R3. At the highest level of DAG production (240 minutes of reaction time), the amount of DAG produced (˜13%) was much lower than that produced by reaction R3, at the same reaction time (˜25%).

C. Effect of Post-Reaction Filtration

For all reaction products, filtration was performed as described elsewhere herein. The filtration time required for each reaction was as follows:

R1: Filtration at 105° C. complete at 45 minutes, with product solidifying in the process.

R2: Filtration at 105° C. complete at 53 minutes, with product solidifying in the process.

R3: Filtration @ 110° C.: complete at 4 minutes

R4: Filtration @ 110° C. complete at 12 minutes

R5: Filtration @ 110° C.: complete at 4 minutes

Since R1 and R2 contained 4% (w/w) glycerin, it follows that the filtration would be slow, given the interaction between the glycerin and Trisyl/Filter Aid mixture. At a certain content of glycerin, the Trisyl/Filter Aid mixture forms a colloidal structure that prevents normal filtration. This is confirmed by the faster filtration processed observed in reactions R3 and R4, which started with 2% (w/w) glycerin. The reason why reaction R3 filtered faster than R4, might be due to the level of DAG produced, and the remaining glycerin left in the product. R3 produced significantly higher amounts of DAG than R4.

D. Effect of Palm Stearin (Palsgaard 6118) as a Raw Material

Reaction conditions similar to the ones described in Example 38, except 0.125% (w/w) Ca(OH)₂ catalyst, were used to produce DAG from Palsgaard 6118.

Palsgaard 6118 is derived from palm and is marketed as a crystallizer. Reaction R5 (see Table 12), was performed in duplicate and the amount of DAG produced was ˜39%. Comparing the TAG species in the product with those in the physical blend of the starting reagents (Palsgaard 6118 and glycerin), the concentration of PPP, POP, and PSP was reduced by 49, 32, and 59%, respectively. As observed with fully hydrogenated palm, the TAG profile of the product was chemically different than that from the original blend.

In certain embodiment, filtration of similar subsequent reactions containing 4% (w/w) glycerin was conducted by treating the product with (0.5% (w/w)) Trisyl S-615 and (0.5% (w/w)) Filter Aid at 125°-130° C. (257°-266° F.), mixing for 10 minutes, and filtering at ˜130° C., decanting the cake. Under these filtration conditions, the product was successfully filtered in approximately 5 minutes.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed is:

1. A spread composition comprising about 40-65% water, 1-25% seeding agent, 1-15% cellulose fiber, and 10-40% base oil based on the total weight of the composition, wherein the seeding agent comprises a blend of a diacylglyceride, a monoacylglyceride and a triacylglyceride.

2. The spread composition of claim 1, wherein water is present in about 45-60% based on the total weight of the composition.

3. The spread composition of claim 1, wherein the seeding agent is present in about 1-20% based on the total weight of the composition.

4. The spread composition of claim 1, wherein the seeding agent is present in about 3-19% based on the total weight of the composition.

5. The spread composition of claim 1, wherein the seeding agent comprises about 20-50% diacylglyceride based on the total weight of the seeding agent, and a remaining portion comprising monoacylglyceride, triacylglyceride, and free fatty acids.

6. The spread composition of claim 1, wherein the seeding agent comprises about 30-35% diacylglyceride based on the total weight of the seeding agent, and a remaining portion comprising monoacylglyceride, triacylglyceride, and free fatty acids.

7. The spread composition of claim 1, wherein the seeding agent comprises about 20-50% diacylglyceride, about 4-15% monoacylglyceride and a remaining portion comprising triacylglyceride, and free fatty acids.

8. The spread composition of claim 1, wherein the seeding agent about 35-55% triacylglyceride based on the total weight of the seeding agent.

9. The spread composition of claim 1, wherein the seeding agent comprises about 30-35% diacylglyceride, about 8-10% monoacylglyceride and about 40-55% triacylglyceride based on the total weight of the seeding agent.

10. The spread composition of claim 1, wherein the cellulose fiber is present in about 4-10% based on the total weight of the composition.

11. The spread composition of claim 1, wherein the cellulose fiber has an average fiber length of about 15-60 micron.

12. The spread composition of claim 1, wherein the cellulose fiber has an average fiber length of about 25-35 micron.

13. The spread composition of claim 1, wherein the cellulose fiber has an average fiber thickness of about 0.5-5 micron.

14. The spread composition of claim 1, wherein the cellulose fiber has an average fiber thickness of about 1-2 micron.

15. The spread composition of claim 1, wherein the cellulose fiber comprises a cellulose fiber from wood pulp, bamboo, pea, citrus fruit, sugar beets, wheat and cottonseed.

16. The spread composition of claim 1, wherein the cellulose fiber comprises a cellulose fiber from wood pulp, bamboo, pea, citrus fruit, and sugar beets.

17. The spread composition of claim 1, wherein the base oil comprises a vegetable oil, rapeseed oil, animal fat, corn oil, canola oil, olive oil, cottonseed oil, safflower oil, palm oil, soybean oil, sunflower oil, peanut oil, coconut oil, or a mixture thereof.

18. The spread composition of claim 1, wherein the base oil comprises soybean oil, palm oil or a mixture thereof.

19. The spread composition of claim 1, wherein the base oil comprises soybean oil and an oil blend.

20. The spread composition of claim 19, wherein the oil blend comprises palm oil, palm stearin, soybean oil and an emulsifier.

21. The spread composition of claim 20, wherein the emulsifier comprises monoacylglycerides, diacylglycerides, polyglycerol esters and lecithin.

22. The spread composition of claim 21, wherein the emulsifier comprises monoacylglycerides and diacylglycerides.

23. The spread composition of claim 1, wherein the base oil is present in about 10-30% based on the total weight of the composition.

24. The spread composition of claim 1 comprising about 40-55% water, 7-20% seeding agent, 3-6% cellulose fiber, and 10-30% base oil based on the total weight of the composition.

25. The spread composition of claim 20 comprising about 53% water, 17% seeding agent, 5% cellulose fiber, about 12% oil blend and about 7% soybean oil based on the total weight of the composition.

26. The spread composition of claim 1 further comprising an anti-molding agent.

27. The spread composition of claim 1, wherein the anti-molding agent is potassium sorbate.

28. A food product comprising the spread composition of claim 1.

29. An icing comprising the spread composition of claim 1.

30. The icing of claim 27 comprising about 53% water, about 17% seeding agent, about 5% cellulose fiber, about 12% oil blend and about 7% soybean oil based on the total weight of the composition.

31. A method of preparing a spread composition comprising about 40-65% water, about 1-25% seeding agent, about 1-15% cellulose fiber, and about 10-40% base oil based on the total weight of the composition, the method comprising the steps of
a) mixing a seeding agent with a base oil to obtain an oil mixture,
b) blending together the oil mixture and a cellulose fiber to obtain an oil-fiber blend, and
c) mixing an aqueous phase with the oil-fiber blend to obtain a homogeneous composition.

32. The method of claim 31, wherein steps a), b) or c) are carried out at a temperature of about 50-80° C.

33. The method of claim 31 further comprising cooling the homogeneous composition.

34. The method of claim 33, wherein the cooling step is performed at a temperature of about 10-25° C.
